(19) United States
(12) Patent Application Publication
(10) Pub. No.: US 2013/0032093 A1
(43) Pub. Date: Feb. 7, 2013

(54) ARTICLE AND METHOD FOR SUPPORTING A PET

(71) Applicant: Loretta E. Kem, San Antonio, TX (US)

(72) Inventor: Loretta E. Kem, San Antonio, TX (US)

(21) Appl. No.: 13/196,987

(22) Filed: Aug. 3, 2011

(51) Int. Cl. A01K 29/00

(52) U.S. Cl. 119/28.5

(57) ABSTRACT

An article for supporting a pet in the lap area of a caregiver includes a cushion specially adapted to conform to the abdominal torso of a caregiver and a strap specially adapted to maintain the cushion in conforming position about the abdominal torso of the caregiver. In use, the provided article is positioned about the abdominal torso of the caregiver, the strap is placed about the lumbar region of the caregiver and tightened in place and a pet, such as a dog or cat, is placed atop the cushion.

### FIELD OF THE INVENTION

The present invention relates to animal husbandry and, specifically, to pet care. More particularly, the invention relates to an article and method for supporting a pet in the lap of a caregiver.

### BACKGROUND OF THE INVENTION

The voluntary care of small pets, such as dogs, cats and the like, is a favorite endeavor of people throughout the world. To be sure, the caregiver and pet alike often establish a very personal relationship in which they enjoy the physical contact of one another. In particular, the pet will often find comfort in its caregiver's lap and arms, which in turn gives the caregiver great satisfaction.

Unfortunately, however, this manner of supporting a pet sometimes results in inadvertent injury by the pet to the caregiver. In particular, the pet may scratch the caregiver if it becomes frightened or otherwise feels unstable in the lap of the caregiver. Additionally, some pets simply have very sharp claws and inadvertently injure the caregiver in any case. Still further, especially with larger pets, the caregiver's lap may not provide a sufficiently large enough support surface for the pet to be fully comfortable. While many people will simply utilize an ordinary pillow or cushion as an intermediate support for the pet, Applicant has found that this solution is lacking In particular, the utilized ordinary pillow or cushion will often slide out from between the caregiver and supported pet causing the caregiver to have to devote attention to the pillow or cushion rather than to the pet. Still further, however, an in a sever limitation of the prior art, an ordinary pillow or cushion generally does not sufficiently conform to the abdominal torso region of the caregiver as to enable the pet to be snuggly held by the caregiver without the pet's legs or other body parts slipping between the ordinary pillow or cushion and the caregiver's abdominal torso region.

With these limitations of the prior art clearly in mind, it is therefore an overriding object of the present invention to improve generally over the prior art in the manner of care afforded a pet. In particular, it is an object of the present invention to provide an article of manufacture and method for its use such that there is provided a pet support surface that snuggly engages a caregiver. Further, it is an object of the present invention to provide such an article of manufacture and method for its use that may be securely affixed to the caregiver such that the obtained snug conformation is securely maintained. Still further, it is an object of the present invention to provide such an article of manufacture that is economical to manufacture and simple to maintain, thereby ensuring the widest availability for distribution and use.

### SUMMARY OF THE INVENTION

In accordance with the foregoing objects, the present invention—an article for supporting a pet in the lap area of a caregiver—generally comprises a cushion adapted to conform to the abdominal torso of a caregiver and a strap adapted to maintain the cushion in conforming position about the abdominal torso of the caregiver. In use, the provided article is positioned about the abdominal torso of the caregiver, the strap is placed about the lumbar region of the caregiver and tightened in place and a pet, such as a dog or cat, is placed atop the cushion.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a perspective view, the preferred embodiment of the pet support of the present invention as operably utilized by a caregiver to hold a pet in the lap region of the caregiver;

FIG. 2 shows, in a top perspective view, details of the construction of the pet support of FIG. 1;

FIG. 3 shows, in a front elevation view, additional details of the construction of the pet support of FIG. 1; and

FIG. 4 shows, in a perspective view, details of the use of the pet support of FIG. 1, particularly showing the manner of operable application to a caregiver of the pet support preparatory to the use as depicted in FIG. 1.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

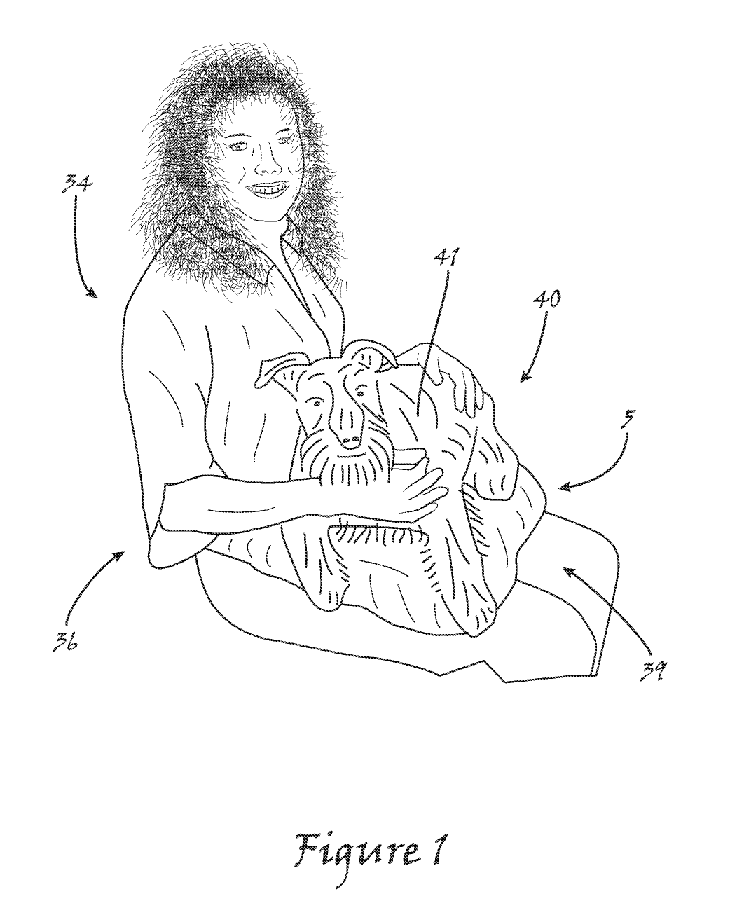

Referring now to the figures, and to FIG. 1 in particular, the preferred embodiment of the pet support 5 of the present invention is shown to generally comprise a cushion 10 adapted for conforming placement substantially about the abdominal torso 35 and sides 36 of a caregiver 34 and upon the top 11 of which a pet 40 such as, for example, a dog 41 may comfortably rest. Additionally, and as will be described in greater detail further herein, the pet support 5 comprises a strap 26 for securing the pet support 5 in place atop the lap 30 of the caregiver 34.

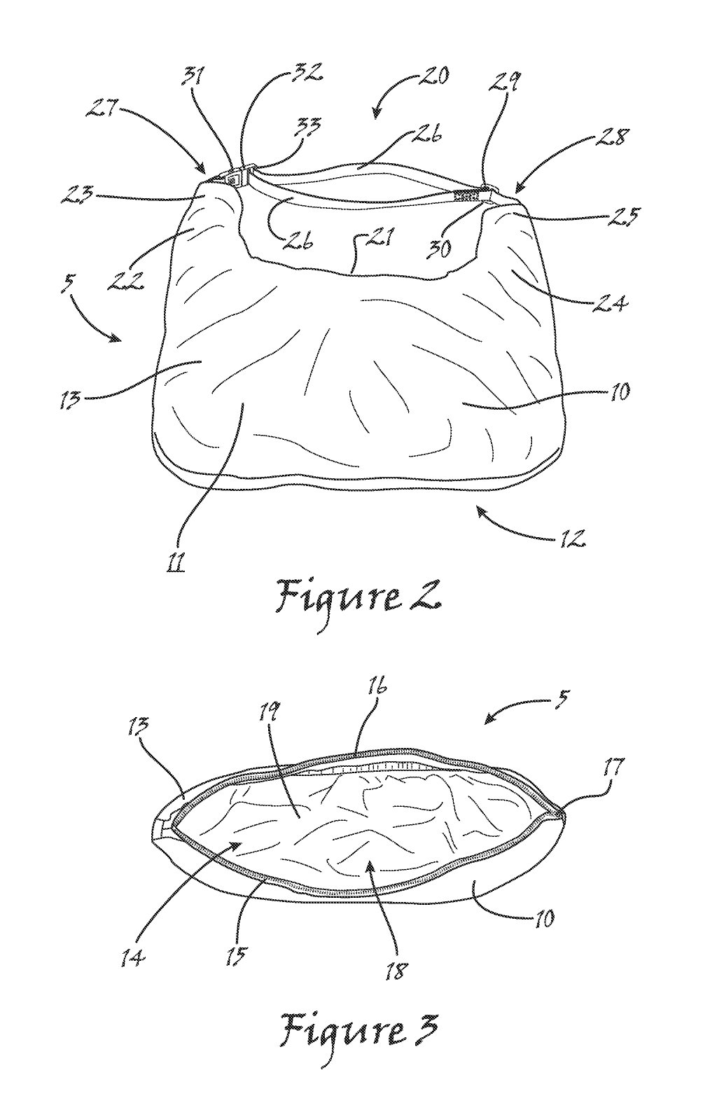

As shown in FIG. 2, a critical aspect of the present invention is the provision as part of the cushion 10 of a plurality of projections 22, 24, the projections being rearward oriented at the rear 20 of the cushion 10. In particular, a first rearward projection 22 is provided in the region of the cushion 10 generally conforming to a first side 36 of a caregiver 34 and a second rearward projection 24 is provided in the region of the cushion 10 generally conforming to a second, opposite side 36 of the caregiver 34. Critical to the present invention, the provided projections 22, 24 and the rear portion 20 of the cushion are manufactured such that a concave form 21 is presented by the cushion over the portion thereof generally extending from the end 23 of the first rearward projection 22 to the end 25 of the second rearward projection 24. In this manner the cushion 10 is adapted to conform to the abdominal torso 35 of a caregiver 34 and the phrase “adapted to conform to the abdominal torso of a caregiver” is expressly defined herein to be limited to and require the structure described in this paragraph and generally depicted in FIG. 2.

Additionally and as previously mentioned, the pet support 5 of the present invention also comprises a strap 26, which may comprises nylon or like material webbing, adapted to secure the pet support 5 in place atop the lap 30 of the caregiver 34. In order to facilitate securement and removal of the pet support 34 to and from the caregiver 34, the strap 26 comprises a releasable fastener 31 such as, for example, the side release buckle 32 depicted in FIG. 2. In the most preferred embodiment of the present invention, the strap 26 also comprises a length adjustment 29 such as, for example, the slide adjuster 30 depicted in FIG. 2. In the alternative or in addition to a separately provided length adjustment 29, however, the releasable fastener 31 may be provided with an integral length adjustment 33.

While the strap 26 as thus far described may be implemented in many forms according to the preferences of the implementer, it is a critical aspect of the present invention that the strap 26 connect at a first end 27 thereof generally to the end 23 of the first rearward projection 22 and that the strap 26 connect at a second end 28 thereof generally to the end 25 of the second rearward projection 24 and that the strap 26 be provided with at least one length adjustment 29, 33. In this manner the strap 26 is adapted to maintain the cushion 10 in conforming position about the abdominal torso 35 of a caregiver 34 and the phrase “adapted to maintain said cushion in conforming position about the abdominal torso of the caregiver” is expressly defined herein to be limited to and require the structure described in this paragraph and generally depicted in FIG. 2.

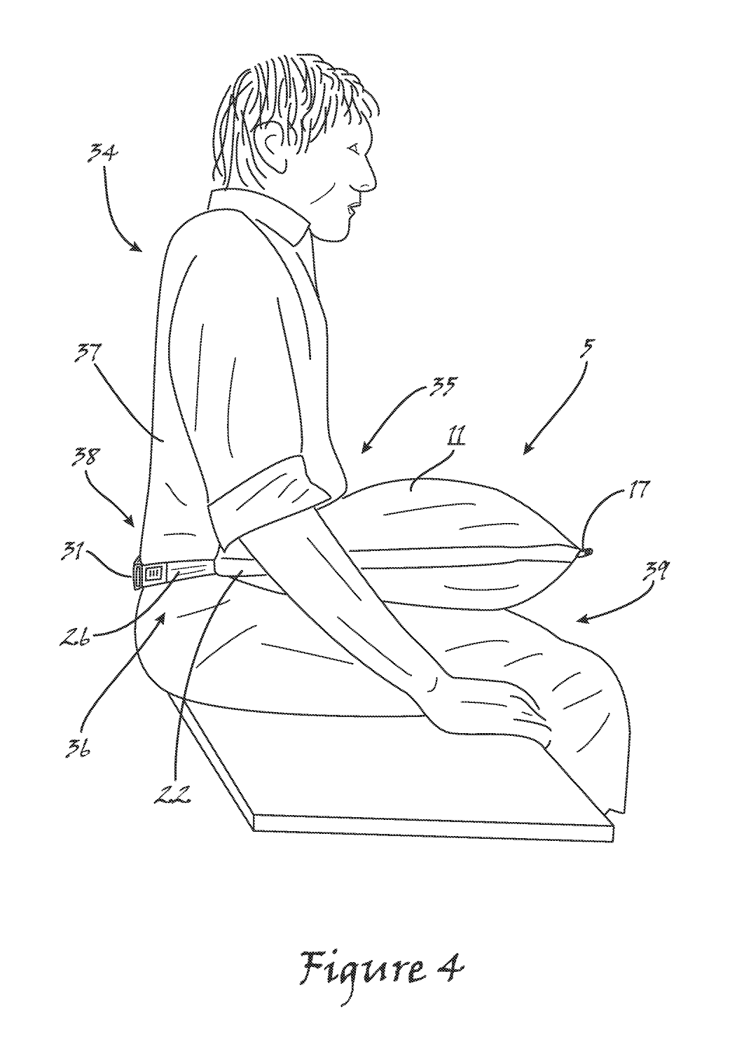

In any case, as particularly shown in FIG. 3, the cushion 10 of the pet support 5 of the present invention preferably comprises a fabric or like material cover 13 having at the front 12 side thereof an opening 14 through which filler 18 such as, for example, foam, synthetic fill, feathers, down or the like may be inserted or removed. As shown in the figures, the opening has provided in connection therewith a closure 15 such as, for example, a zipper 16 with slider 17. As will be appreciated by those of ordinary skill in the art, the described construction has the benefit of making the pet support 5 of the present invention easily maintainable. In particular, the filler 18 may be removed and replaced as necessary with extended use and/or the cover 13 may be removed for periodic laundering. Still further, it is noted that the filler 18 may also be provided with a preferably hydrophobic protective cover 19 in order to prevent damage to the filler 18 in the case of the pet 40 soiling the pet support 5.

Referring now to FIG. 4, the manner of application of the pet support 5 of the present invention preparatory to use is shown to comprise the steps of placing the cushion in the lap 39 area of the caregiver 34 and positioning the strap 26 about the lumbar region 38 of the back 37 of the caregiver 34. With the strap 26 so positioned, whether by slipping the strap 26 over the head and arms of the caregiver, by pulling the strap 26 up and over the legs and waist of the caregiver 34 or by utilizing a provided releasable fastener 31, the strap 26 is then tightened to secure the cushion 10 in place about the abdominal torso 35 of the caregiver 34 such that the concave form 21 of the cushion 10 is snuggly pressed against the abdominal torso 35 of the caregiver 34 from one side 36 of the caregiver 34 to the other side 36 of the caregiver 34. With the pet support 5 thus operably applied to the caregiver 34, the pet 40 may be comfortably held generally in the lap 39 of the caregiver 34 as shown in FIG. 1.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, it should be recognized that while it is critical to the present invention that the rear 20 of the cushion 10 be shaped such that the cushion is adapted to conform to the abdominal torso of a caregiver, the remaining portions of the cushion 10 may take on any shape as may be desired in a particular implementation. For example, and without limitation, the forward portion of the cushion may be formed in a semicircle, a geometric design or generally any desired shape. In any case, because the scope of the present invention is much broader than any particular embodiment, the foregoing detailed description should not be construed as a limitation of the scope of the present invention, which is limited only by the claims appended hereto.

What is claimed is:

1. An article for supporting a pet in the lap area of a caregiver, said article comprising:
a cushion adapted to conform to the abdominal torso of a caregiver; and
a strap adapted to maintain said cushion in conforming position about the abdominal torso of the caregiver.

2. The article for supporting a pet in the lap area of a caregiver as recited in claim 1, wherein said strap comprises a releasable fastener.

3. The article for supporting a pet in the lap area of a caregiver as recited in claim 2, wherein said releasable fastener comprises an integral length adjustment.

4. The article for supporting a pet in the lap area of a caregiver as recited in claim 1, wherein said cushion comprises a cover containing filler.

5. The article for supporting a pet in the lap area of a caregiver as recited in claim 4, wherein said cover comprises fabric.

6. The article for supporting a pet in the lap area of a caregiver as recited in claim 4, wherein said cover comprises an opening.

7. The article for supporting a pet in the lap area of a caregiver as recited in claim 6, wherein said opening is provided with a closure.

8. The article for supporting a pet in the lap area of a caregiver as recited in claim 7, wherein said closure comprises a zipper.

9. A method for supporting a pet in the lap area of a caregiver, said method comprising the steps of:
providing a pet support, said pet support comprising:
a cushion adapted to conform to the abdominal torso of a caregiver; and
a strap adapted to maintain said cushion in conforming position about the abdominal torso of the caregiver;
positioning said pet support about the abdominal torso of the caregiver;
placing said strap about the lumbar region of the caregiver;
tightening said strap in place; and
placing a pet atop said cushion.

10. The method for supporting a pet in the lap area of a caregiver as recited in claim 9, wherein said placing said strap step comprises operating a releasable fastener.

11. The method for supporting a pet in the lap area of a caregiver as recited in claim 10, wherein said tightening said strap in place step comprises operating a length adjustment integrally provided with said releasable fastener.

12. The method for supporting a pet in the lap area of a caregiver as recited in claim 9, wherein said pet comprises a dog.

13. The method for supporting a pet in the lap area of a caregiver as recited in claim 9, wherein said pet comprises a cat.
